(19) United States
(12) Patent Application Publication
(10) Pub. No.: US 2018/0242385 A1
(43) Pub. Date: Aug. 23, 2018

(54) METHOD AND APPARATUS FOR SUPPORTING VEHICLE-TO-INFRASTRUCTURE OR VEHICLE-TO-VEHICLE SERVICES

(71) Applicant: NOKIA SOLUTIONS AND NETWORKS OY, Espoo (FI)

(72) Inventors: Devaki CHANDRAMOULI, Plano, TX (US); Rainer LIEBHART, Munich (DE); Juergen MERKEL, Renningen (DE); David NAVRATIL, Helsinki (FI)

(21) Appl. No.: 15/750,673

(22) PCT Filed: Aug. 7, 2015
(86) PCT No.: PCT/US15/44281

§ 371 Date: Feb. 6, 2018

(51) Int. Cl. H04W 76/16; H04W 4/08; H04W 76/12; H04W 4/44; H04W 4/46

(52) U.S. Cl. CPC H04W 76/16; H04W 4/08; H04W 4/46; H04W 4/44; H04W 76/12

(57) ABSTRACT

A method and apparatus may include establishing a first bearer for user equipment to transmit uplink communication to an application server. The user equipment is configured for vehicle-to-vehicle or vehicle-to-infrastructure communication. The method may also include establishing a second bearer for the application server to transmit downlink communication to the user equipment obtaining V2X services. The method may also include transmitting uplink and downlink communication between the user equipment and the application server.

### BACKGROUND

### Field

Embodiments of the present invention relate to supporting vehicle-to-infrastructure or vehicle-to-vehicle services.

### Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

### SUMMARY

According to a first embodiment, a method may include establishing, by a network node, a first bearer for user equipment to transmit uplink communication to an application server. The user equipment is configured for vehicle-to-vehicle or vehicle-to-infrastructure communication. The method may also include establishing a second bearer for the application server to transmit downlink communication to the user equipment obtaining V2X services. The method may also include transmitting uplink and downlink communication between the user equipment and the application server.

In the method of the first embodiment, the establishing the first bearer comprises establishing the first bearer by an evolved Node B.

In the method of the first embodiment, the establishing the first bearer comprises establishing the first bearer for the user equipment to transmit uplink communication to a V2X application server.

In the method of the first embodiment, the establishing the first bearer comprises establishing a unicast bearer. The establishing the second bearer may include establishing a multimedia broadcast multicast service bearer, and the network node may include an evolved Node B in a specific area.

In the method of the first embodiment, the transmitting of the downlink communication comprises broadcasting a multicast-broadcast single-frequency network broadcast in an area corresponding to a temporary mobile group identity. The temporary mobile group identity is allocated by the application server.

In the method of the first embodiment, the transmitting of the downlink communication comprises broadcasting a single-cell point-to-multipoint broadcast in an area corresponding to a temporary mobile group identity. The temporary mobile group identity is allocated by the application server.

In the method of the first embodiment, the method may also include establishing an infrastructure-to-vehicle broadcast channel. The infrastructure-to-vehicle broadcast channel is dedicated to the broadcasting of infrastructure-to-vehicle messages. The method may also include broadcasting an indication that the infrastructure-to-vehicle broadcast channel is supported. The indication comprises an indication broadcasted over a system information broadcast.

In the method of the first embodiment, the method may include establishing a tunnel between a first local gateway and a second local gateway, when the user equipment has moved beyond a serving area of the first local gateway into a serving area of the second local gateway.

In the method of the first embodiment, the transmitting the uplink communication between the user equipment and the application server may include determining a destination internet protocol address of the uplink communication. The transmitting the uplink communication between the user equipment and the application server may also include determining an appropriate tunnel for the uplink communication based on the determined internet protocol address, a tunnel identity, and/or port numbers. A routing table may indicate the appropriate tunnel for communication with the determined internet protocol address. The uplink communication may be forwarded towards a local gateway and the application server via the determined tunnel.

According to a second embodiment, an apparatus may include at least one processor. The apparatus may also include at least one memory including computer program code. The at least one memory and the computer program code may be configured, with the at least one processor, to cause the apparatus at least to establish a first bearer for user equipment to transmit uplink communication to an application server. The user equipment may be configured for vehicle-to-vehicle or vehicle-to-infrastructure communication. The apparatus may also be caused to establish a second bearer for the application server to transmit downlink communication to the user equipment obtaining V2X services. The apparatus may also be caused to transmit uplink and downlink communication between the user equipment and the application server.

In the apparatus of the second embodiment, the apparatus may include an evolved Node B.

In the apparatus of the second embodiment, the establishing the first bearer may include establishing the first bearer for the user equipment to transmit uplink communication to a V2X application server.

In the apparatus of the second embodiment, the establishing the first bearer may include establishing a unicast bearer, and the establishing the second bearer may include establishing a multimedia broadcast multicast service bearer, and the apparatus may include an evolved Node B in a specific area.

In the apparatus of the second embodiment, the transmitting of the downlink communication comprises broadcasting a multicast-broadcast single-frequency network broadcast in an area corresponding to a temporary mobile group identity. The temporary mobile group identity may be allocated by the application server.

In the apparatus of the second embodiment, the transmitting of the downlink communication may include broadcasting a single-cell point-to-multipoint broadcast in an area corresponding to a temporary mobile group identity. The temporary mobile group identity may be allocated by the application server.

In the apparatus of the second embodiment, the apparatus may be further caused to establish an infrastructure-to-vehicle broadcast channel. The infrastructure-to-vehicle broadcast channel may be dedicated to the broadcasting of infrastructure-to-vehicle messages. The apparatus may also be caused to broadcast an indication that the infrastructure-to-vehicle broadcast channel is supported. The indication comprises an indication broadcasted over a system information broadcast.

In the apparatus of the second embodiment, the apparatus may also be further caused to establish a tunnel between a first local gateway and a second local gateway, when the user equipment has moved beyond a serving area of the first local gateway into a serving area of the second local gateway.

In the apparatus of the second embodiment, the transmitting the uplink communication between the user equipment and the application server includes determining a destination internet protocol address of the uplink communication. The transmitting the uplink communication may also include determining an appropriate tunnel for the uplink communication based on the determined internet protocol address, a tunnel identity, and/or port numbers. A routing table indicates the appropriate tunnel for communication with the determined internet protocol address, and the uplink communication is forwarded towards a local gateway and the application server via the determined tunnel.

According to a third embodiment, a computer program product may be embodied on a non-transitory computer readable medium. The computer program product configured to control a processor to perform a method according to the first embodiment.

According to a fourth embodiment, an apparatus may include establishing means to establish a first bearer for user equipment to transmit uplink communication to an application server. The user equipment may be configured for vehicle-to-vehicle or vehicle-to-infrastructure communication. The apparatus may also include establishing means to establish a second bearer for the application server to transmit downlink communication to the user equipment obtaining V2X services. The apparatus may also include transmitting means to transmit uplink and downlink communication between the user equipment and the application server.

### BRIEF DESCRIPTION OF THE DRAWINGS

For proper understanding of the invention, reference should be made to the accompanying drawings, wherein:

FIG. 1 illustrates an example Evolved Packet Core architecture.

FIG. 2 illustrates a first option of enhancing broadcasting, in accordance with certain embodiments of the present invention.

FIG. 3 illustrates a second option of enhancing broadcasting, in accordance with certain embodiments of the present invention.

FIG. 4 illustrates a third option of enhancing broadcasting, in accordance with certain embodiments of the present invention.

FIG. 5 illustrates a flow diagram of a method in accordance with certain embodiments of the present invention.

FIG. 6 illustrates an apparatus in accordance with certain embodiments of the invention.

FIG. 7 illustrates an apparatus in accordance with certain embodiments of the invention.

### DETAILED DESCRIPTION

Certain embodiments of the present invention relate to supporting vehicle-to-infrastructure or vehicle-to-vehicle services. Certain embodiments may be used in conjunction with Evolved Packet System technology. Evolved Packet System (EPS) is generally considered to be the successor of General Packet Radio System (GPRS). EPS provides a new radio interface and new packet core network functions for performing broadband wireless data access. Such EPS core network functions include functions performed by the Mobility Management Entity (MME), the Packet Data Network Gateway (PDN-GW), and the Serving Gateway (S-GW).

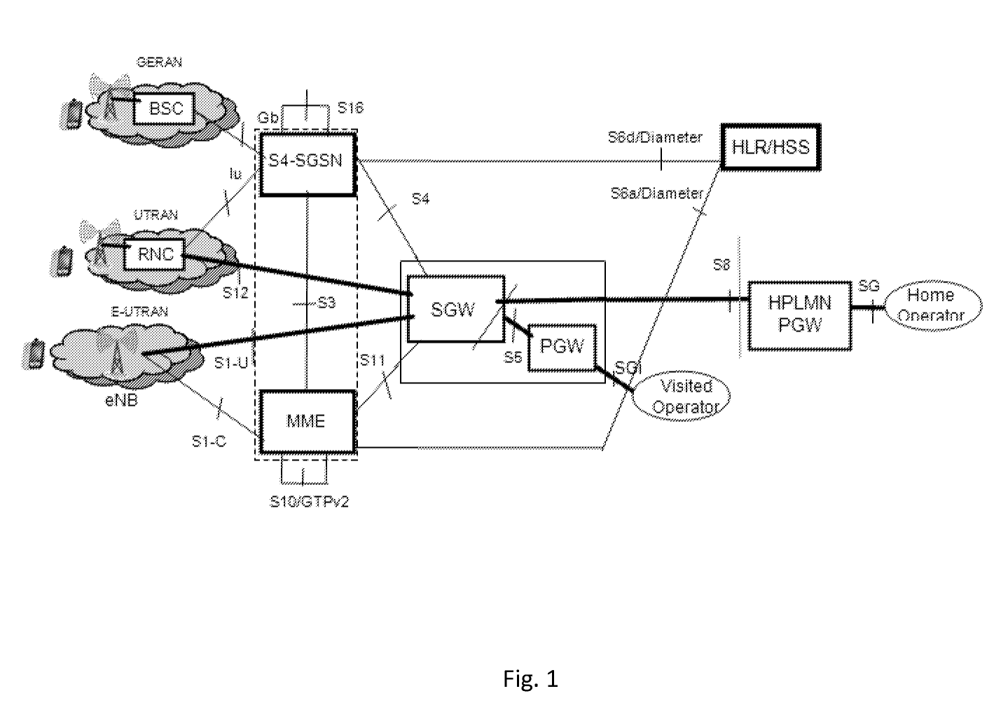

FIG. 1 illustrates an example Evolved Packet Core architecture. A common packet domain Core Network may be used for implementing GSM Edge Radio Access Network (GERAN) and UMTS Terrestrial Radio Access Network (UTRAN) technologies. This common Core Network may provide GPRS services.

An LTE system may be envisioned to support services like Vehicle-to-Infrastructure and/or Vehicle-to-Vehicle (V2X) communication, and these features may be considered to be a part of 3GPP Release 14 work in SA1/SA2.

Mobile-Edge Computing (MEC) is a cloud environment that supports communication with ultra-low latency, and MEC is currently being specified by European Telecommunications Standards Institute (ETSI). MEC may be assumed to host an application, and MEC may be assumed to be close to an evolved Node B.

A previous approach for providing a cloud environment is the Radio Access Cloud Server (RACS). RACS provides a cloud computation platform at the evolved Node B (eNB) for different applications. Such applications are, for example, applications that provide caching and header enrichment, and the applications may be applied on a communication path between a user equipment (UE) and a server that is located beyond an SGi interface.

V2X communication, as described by ETSI Intelligent Transport Systems (ITS), may include two parts: (1) Vehicle-to-Vehicle (V2V) communication, and (2) Vehicle-to-Infrastructure (V2I) communication. Vehicle-to-Vehicle (V2V) communication may comprise communication that is established directly between traffic participants, without a network in the communication path. Vehicle-to-Infrastructure (V2I) and Infrastructure-to-Vehicle (I2V) communication may comprise communication where there is a network in the communication path. V2I/12V may serve several purposes, and one relevant purpose is to enable communication between traffic participants. Although the traffic participants (vehicles) may be close to each other, the traffic participants may not be able to communicate directly. For example, the traffic participants may not be able to communicate directly due to obstacles (such as buildings) in the radio path.

V2I/I2V may provide data about a vehicle's current speed and a location of other vehicles. Such data can help vehicles to avoid accidents and/or to avoid road congestion. Certain embodiments of the present invention are directed to V2I/I2V communication. With certain embodiments, V2I/I2V may have to operate in accordance with a same latency and a same timing requirement as V2V.

When 3GPP technology is used for V2I/I2V, certain difficulties may arise. In the current network setup, V2I communication (running on a user plane) is performed via a central entity (such as a P-GW). Performing V2I communication in this manner may add extra delay to the communication. If local break out is used for V2I, latency can be improved, but this improvement is achieved at the expense of an increased likelihood of service disruption due to mobility. The service disruption may result in a lack of service continuity, for example. Further, current broadcast mechanisms (such as MBMS in LTE) are generally optimized for large areas, which is generally in contradiction with the requirement for V2X that requires information to be broadcasted in a local area.

In general, implementing V2X communication may be difficult because it may be difficult to enable communication between mobile devices, via the network, with minimum latency, while also providing service continuity for mobile devices. The communication that is enabled between devices (via the network) may be V2I/I2V communication. In the course of enabling the communication between devices, one goal is to utilize MEC capabilities for V2I/I2V services, where a corresponding server application is assumed to run on top of a MEC platform. The corresponding server application may be a V2I/I2V Application Server (AS) and/or a V2X AS. A client application on the devices (such as, for example, user equipment (UEs) of the traffic participants) may provide data to the server application, where the server application may be responsible for a certain geographical area. The corresponding server application may receive data from the client application and may later distribute its own communication to the devices in the server application's service area. The corresponding server application may distribute the communication using unicast or broadcast mechanisms.

V2X communication may be supported via unicast communication and/or broadcast communication. The communication may occur within a traditional Multicast-broadcast single-frequency network (MBSFN), as specified in Technical Specification 23.246, or in accordance with single-cell point-to-multipoint (SC-PTM) communication. Local-IP-Access/Selected-IP-Traffic-Offload (LIPA/SIPTO) may be performed for low latency services. Certain methods may also establish a packet data network (PDN) connection to a central packet gateway (P-GW) (where the central P-GW corresponds to an anchor point). Another option for supporting V2I is via proximity services (ProSe) communication.

The current 3GPP specification supports establishment of a PDN connection between a user equipment and a P-GW and/or a local gateway (L-GW). Normally, a PDN connection is established between the UE and the P-GW, when the P-GW is in a central location. The user equipment (UE) may remain anchored with the P-GW, regardless of where the UE moves across the network. Thus, a seamless service continuity may be offered to the UE.

However, a PDN connection to a central P-GW is not suitable for V2X use cases, where a connection to local servers (via a L-GW) is needed. The PDN connection to L-GW is possible with Local IP Access (LIPA) and Selected IP Traffic Offload (SIPTO) functions. However, the problem with SIPTO and LIPA is that internet protocol (IP) data session continuity is generally not supported when there is user mobility. See 3GPP TS 23.401. When the UE moves between cells, the lack of IP data session continuity may impact the service continuity because a latency may exist when a PDN connection is re-established/established (with an L-GW).

As described above, the use of Proximity services (ProSe) may also be a possible method for supporting V2X use cases. Proximity services may be used to establish direct communication between devices, for example.

However, ProSe communication may not be sufficiently reliable for providing V2X services to users that are facing life-threatening situations. ProSe communication may not be sufficiently reliable due to, for example, interference, a lack of coverage, and/or a limited range of communication.

Further, existing Multimedia Broadcast Multicast Service may also have shortcomings when used to support V2X use cases. When using existing Multimedia Broadcast Multicast Service (MBMS) to broadcast data to vehicles in a certain area, certain shortcomings may be apparent. MBMS technology may not be suitable for broadcasting in a small and dynamically changing area, nor is MBMS technology suitable for broadcasting data to a small group of devices. The MBMS service area is generally pre-configured. For example, each evolved Node B (eNB), as based on a local configuration, is generally aware of the service area(s) to which each eNB belongs to. In contrast, for V2X, the group communication area cannot always be pre-determined in a static fashion. The group communication may need to be determined in a dynamic fashion, for example, based on the nature and/or the location of the vehicles.

Further, the architecture of MBMS systems may be very hierarchical, with many network elements involved. As such, the architecture may increase end-to-end communication delay. Due to the limitations and drawbacks of the previous approaches, an improved architecture may be necessary for supporting V2X communication (especially V2I/I2V communication) in LTE.

In view of the above, certain embodiments of the present invention may support V2X (such as V2I/I2V) services over LTE. Certain embodiments may enable group communication with a low latency, and with a high reliability. Certain embodiments may provide session continuity.

In this context, group communication may mean that UEs (and vehicles) send data that indicates their position, their identity, and their speed in an uplink communication to the network. The network may then provide (broadcast) this data, in downlink, to all UEs (and vehicles) within a certain area. For example, certain embodiments may broadcast the data in downlink, for example, to vehicles in a same cell that a sender of data is camping on.

With certain embodiments, the Application Server may be installed on a mobile edge computing platform or in a radio cloud. Certain embodiments are directed to enhancements for broadcasting communication. Other embodiments are directed to enhancements for unicast communication.

With regard to enhancements to broadcast communication, certain embodiments may be directed to a new broadcast bearer setup that broadcasts traffic from a V2X AS/MEC platform towards an eNB(s). The new broadcast bearer setup may also broadcast data from the eNB(s) towards UE(s). The new broadcast bearer setup may broadcast data towards UE(s) in a serving area of an eNB, via the eNB.

As described in more detail below, a first option for enhancing broadcast communication may enhance MBMS broadcasting that uses an MBSFN. The MBMS broadcast may be enhanced via use of a Temporary Mobile Group Identity (TMGI) (that is allocated by a V2X AS to an eNB) on an MEC platform. With a second option, a broadcasting that uses SC-PTM may be enhanced. Again, this broadcasting may be enhanced via use of TMGI. With a third option, broadcast information may be enhanced using a new broadcast channel. With this third option, a new V2X support indicator may be transmitted over a System Information Broadcast (SIB) in order to indicate support for the new broadcast channel for V2X. For example, the availability and the characteristics of V2X-specific broadcast channels may be indicated in SIB to the UEs that are camping on a cell.

With regards to enhancements to unicast communication, with certain embodiments, a UE may indicate a special Radio Resource Control (RRC) cause. Specifically, certain embodiments may use a special RRC indicator, or may use a special access port name (APN), to select a Local GW that enables low latency communication. Certain embodiments may enable seamless service continuity when the UE moves from one local gateway (GW) to another local gateway (within the constraints of the LTE PDN connection model to ensure backwards compatibility).

With regards to enhancements to broadcast communication, as indicated above, there are possible methods for supporting group communication for providing V2X services. As described above, a first option for enhancing broadcast communication may be directed to enhancing MBMS broadcasting utilizing MBSFN. This first option may achieve the enhancement by using a temporary mobile group identity (TMGI). The TMGI may be allocated by the V2X AS to an eNB (where the V2X AS may be on the MEC platform or in the radio or edge cloud). This first option may allow for a flatter and more optimized end-to-end (e2e) architecture. The AS may be located close to the eNB or even on the same platform as the eNB. Next, a second option for enhancing broadcast communication may be directed to enhancing broadcasting that uses single-cell point-to-multipoint (SC-PTM) broadcasting. This second option may also use a TMGI that is allocated by the V2X AS, in order to enable flatter and optimized e2e architecture. Next, a third option for enhancing broadcast communication may be directed to a new I2V broadcast channel that uses a new I2V support indicator that is transmitted over SIB.

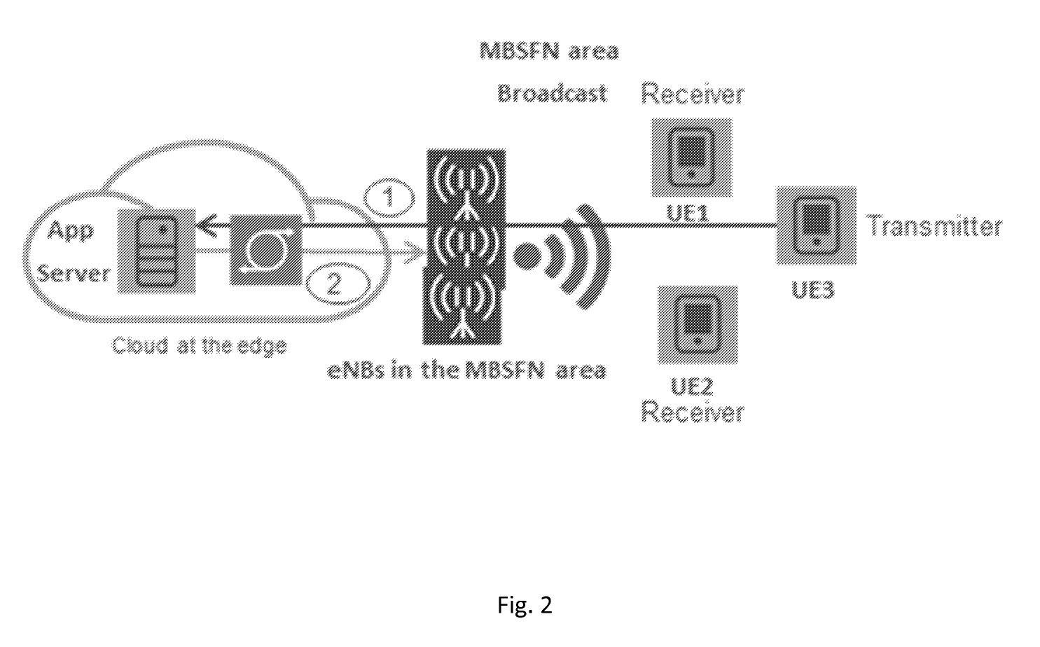

As described above, a first option for enhancing broadcasting may be directed to enhancing MBMS broadcasting that utilizes a multicast-broadcast single-frequency network (MBSFN). FIG. 2 illustrates the first option of enhancing broadcasting, in accordance with certain embodiments of the present invention. With regard to this first option, certain embodiments may introduce functions such as TMGI allocation and IP multicast address allocation to the V2X AS or a BMSC collocated in the V2X AS. In other words, this first option may assume that the V2X AS supports some functions that are currently provided by a Broadcast Multicast Service Center (BM-SC) and MBMS GW. This first option for enhancing broadcasting may also assume that broadcasting occurs in a specific and limited MBSFN area (i.e., an area that includes a limited number of cells).

With this first option for enhancing broadcasting, a first bearer (such as, for example, a unicast bearer) may be established for V2X UE(s) that are trying to send messages to the network, via uplink (UL) communication. The UL path for the unicast bearer should be from the UE, then to the eNB, then to the Local GW, and then to the V2X AS. A Local GW functionality can be supported or co-located in the eNB, in a radio cloud or MEC platform, or in the V2X AS. A second bearer (such as, for example, a MBMS bearer) may be established for UE(s), where the MBMS bearer enables the following path for the broadcasting of downlink (DL) data. The path for the broadcasting of the DL data may be from a V2X AS, then to a Local GW (optionally), then to an eNB(s), and then to UE(s). This implementation may require the V2X AS to support BM-SC functionality (i.e., require the V2X AS to provide a TMGI allocation to the eNB).

This first option for enhancing broadcasting may also require that the V2X AS support MBMS GW functionality, and the first option may establish an IP multicast channel between the V2X AS and eNB(s). For example, the V2X AS should provide an IP multicast address to the eNB, and the eNB should use this IP multicast address in order to receive IP multicasting traffic. Optionally, a local GW (such as the above-described local GW) can also provide this functionality.

In order to support V2X services, the first option for enhancing broadcasting may include the following steps. A V2X UE (such as, for example, a device in a vehicle) may initiate an uplink transmission using the first radio bearer established for V2X. The eNB forwards the traffic towards a V2X AS via a Local GW. The V2X AS receives and processes the message. The V2X AS can request that a broadcast be broadcasted to only certain cells. Once the V2X AS determines that it needs to broadcast to other V2X UE(s), the V2X AS initiates IP multicasting towards the connected eNB(s). The eNB(s) will broadcast the received IP multicast traffic in a certain MBSFN area for a corresponding TMGI.

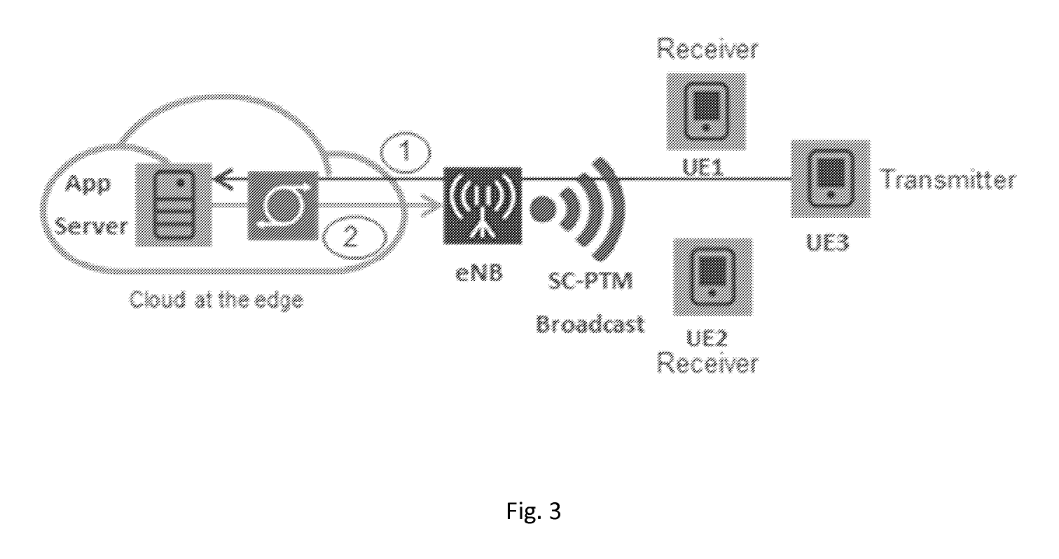

As described above, a second option for enhancing broadcasting may be directed to enhancing single-cell point-to-multipoint (SC-PTM) broadcasting. FIG. 3 illustrates the second option of enhancing broadcasting, in accordance with certain embodiments of the present invention. With regard to this second option, certain embodiments may introduce functions such as TMGI allocation and IP multicasting address allocation to the V2X AS. In other words, this second option may assume that the V2X AS supports functionalities supported by BM-SC and MBMS GW. This second option may also assume that a broadcast occurs in a certain area (such as an area that is defined, for example, by a list of cells). The broadcast may be provided by the AS using a SC-PTM mechanism. This second option is similar to the first option, with the exception that eNB(s) may use SC-PTM, instead of MBSFN, to broadcast data in certain cells. Thus, this second option may require the V2X AS to provide a list of cells where broadcast should be performed.

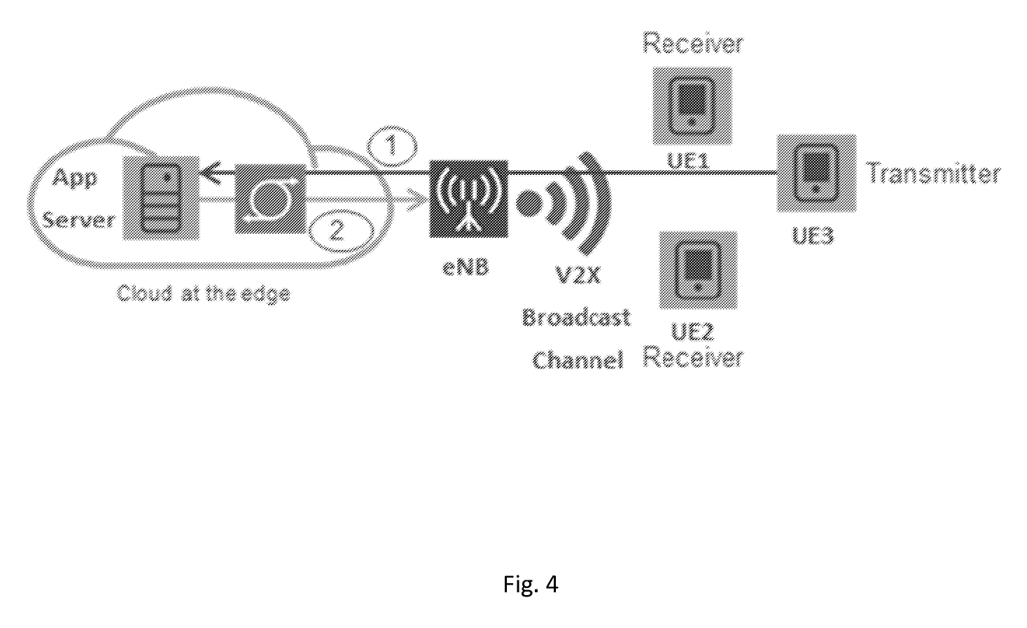

As described above, a third option of enhancing broadcasting may be directed to a new I2V broadcast channel that uses a new I2V support indicator (transmitted over SIB) from the network. FIG. 4 illustrates the third option of enhancing broadcasting, in accordance with certain embodiments of the present invention. With regard to this third option, certain embodiments may introduce a new I2V broadcast channel in order to broadcast I2V messages to devices in a certain area. Both the UE and the network should be able to support the new broadcast channel. The network should indicate support for such a channel with a new I2V support indicator that is transmitted over System Information Broadcast (SIB). This third option does not require any TMGI allocation, as the I2V broadcast channel is isolated from regular MBMS broadcasting and may be dedicated to broadcasting I2V messages. For example, the I2V broadcast channel may be dedicated only to one service, namely, the I2V broadcast service.

This third option of enhancing broadcasting may also require the network and the UE to support the above-described enhancements of the first option. In addition, the third option may include the following requirements: (1) the UE and the network may need to support broadcasting over the new I2V broadcast channel, (2) the network may broadcast its support for I2V broadcasting using a new SIB, and (3) the I2V broadcast channel may need to be enabled for V2X UE(s). The following path may be enabled for DL broadcast. The enabled DL path may be from a V2X AS, then to a Local GW (optionally), then to eNB(s), and then to UE(s). This implementation may require the V2X AS to support MBMS GW functionality such as, for example, establishment of IP multicast between V2X AS (or local GW) and eNB(s). Alternatively, a Local GW may provide this functionality.

In order to support V2X services for the third option of enhancing broadcasting, certain embodiments may include the following steps. The V2X UE (for example, a device in a vehicle) may initiate an uplink transmission using the first radio bearer that is established for V2X. The eNB may forward the traffic towards the V2X AS via a Local GW. The V2X AS may receive and process the message. The V2X AS can then, for example, request broadcasting to only certain cells. Once the V2X AS determines that it needs to broadcast to other UE(s), the V2X AS initiates IP multicasting towards the eNB(s). The eNB(s) will broadcast the received IP multicast traffic in a certain area that is determined by the list of cells using the new V2I broadcast channel, and V2X UE(s) can listen to the V2I broadcast channel.

As described above, there are at least three possible methods (options 1 through 3 above) that are directed to enhancing broadcast communication. In addition to enhancing broadcast communication, certain other embodiments may be directed to enhancements to unicast communication. In order to enhance unicast communication, the UE may indicate a special Radio Resource Control (RRC) case, where the UE uses some special RRC indicator, or uses a special Access Point Name (APN), in order to assist the network in selecting a Local GW that enables low latency communication towards a V2X AS. Certain embodiments may introduce an ability for seamless service continuity, where the UE moves from one Local GW (L-GW) to another L-GW (within the constraints of the LTE PDN connection model to ensure backward compatibility).

With a first option for enhancing unicast communication, enhancements to unicast communication may be supported by enhancing LIPA/SIPTO procedures to support tunnelling from an old L-GW to a new L-GW, as long as the original session is active. One assumption may be that the UE is initially camping in a serving area of an eNB1 and anchored to an L-GW1. Another assumption may be that the UE moves to eNB2, but the UE is beyond the serving area of L-GW1, and the UE is within the serving area of L-GW2. In order to retain service continuity, a same PDN connection may be retained, but a tunnel is established between L-GW2 and L-GW1.

According to a current specification (Technical Specification 23.401 and Technical Specification 24.301), a PDN connection may be deactivated and re-established when the UE connects to a new L-GW2.

In contrast to the previous approaches, certain embodiments of the present invention are directed to an ability for the UE and the network to retain the same PDN connection, when the UE connects to L-GW2. If the UE moves to the service area of L-GW3, a tunnel between L-GW3 and L-GW1 can be established to avoid further involvement of L-GW2.

With a second option to enhance unicast communication, enhancements to unicast communication can be supported by enhancing the eNB to support service aware packet forwarding. For example, the eNB may build a routing table based on destination IP addresses and tunnel IDs, and the eNB may determine an appropriate tunnel to use in order to forward a packet towards an appropriate destination IP address. Specifically, when the IP packet is received by the eNB, the destination IP address/host route for the IP packet is determined and, based on the determined destination IP address/host route, the eNB forwards the packet using the corresponding tunnel towards L-GW and V2X AS.

In view of the above, certain embodiments may fulfil the necessary requirements for V2X (V2I/I2V) communication by offering low latency services and, additionally, by enabling support of (seamless) service continuity. Certain embodiments may also enable group communication that use broadcast services in a more efficient manner, thus utilizing radio resources more efficiently.

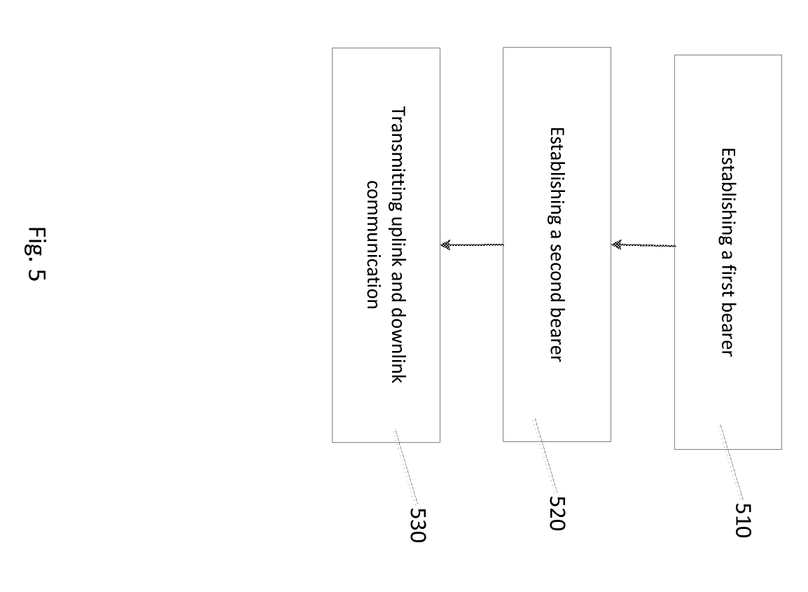

FIG. 5 illustrates a flowchart of a method in accordance with certain embodiments of the invention. The method illustrated in FIG. 5 includes, at 510, establishing, by a network node, a first bearer for user equipment to transmit uplink communication to an application server. The user equipment is configured for vehicle-to-vehicle or vehicle-to-infrastructure communication. The method, at 520, includes establishing a second bearer for the application server to transmit downlink communication to the user equipment obtaining V2X services. The method, at 530, includes transmitting uplink and downlink communication between the user equipment and the application server.

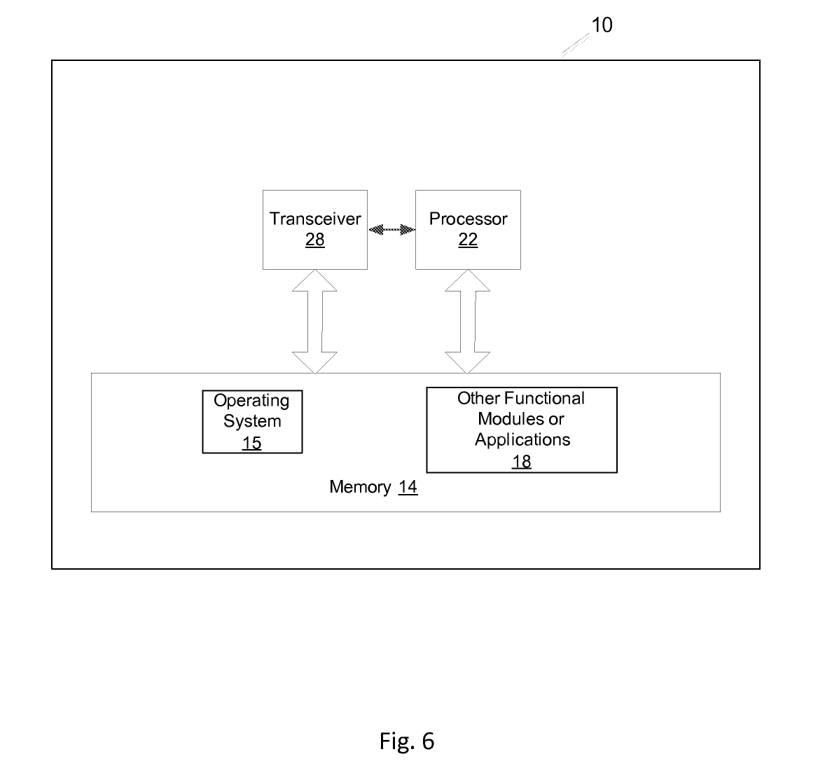

FIG. 6 illustrates an apparatus in accordance with certain embodiments of the invention. In one embodiment, the apparatus can be a network node configured to perform as a base station, an evolved Node B, and/or a user equipment, for example. Apparatus 10 can include a processor 22 for processing information and executing instructions or operations. Processor 22 can be any type of general or specific purpose processor. While a single processor 22 is shown in FIG. 6, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 include any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, preceding of antenna gain/phase parameters, encoding and decoding of individual bits forming a communication message, formatting of information, and overall control of the apparatus 10, including processes related to management of communication resources.

In an embodiment, memory 14 can store software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

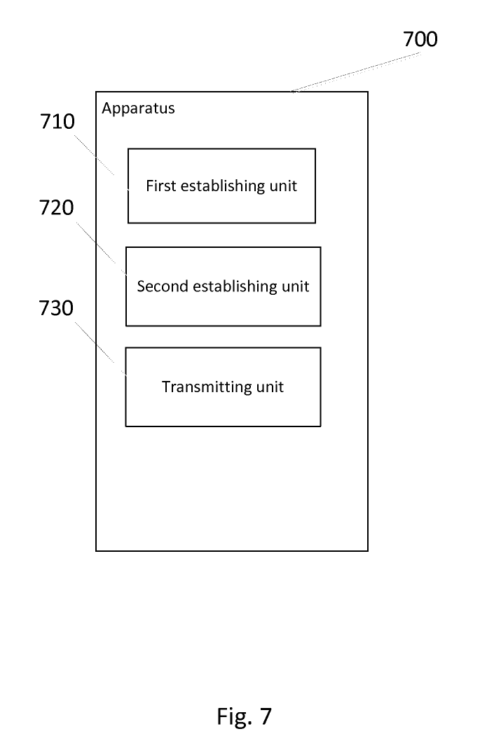

FIG. 7 illustrates an apparatus in accordance with certain embodiments of the invention. Apparatus 700 can be a network element/node such as a base station, an evolved Node B, and/or a user equipment, for example. Apparatus 700 can include a first establishing unit 710 that establishes a first bearer for user equipment to transmit uplink communication to an application server. The user equipment is configured for vehicle-to-vehicle or vehicle-to-infrastructure communication. Apparatus 700 may also include a second establishing unit 720 that establishes a second bearer for the application server to transmit downlink communication to the user equipment obtaining V2X services. Apparatus 700 may also include a transmitting unit 730 that transmits uplink and downlink communication between the user equipment and the application server.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method, comprising:
establishing, by a network node, a first bearer for user equipment to transmit uplink communication to an application server, wherein the user equipment is configured for vehicle-to-vehicle or vehicle-to-infrastructure communication;
establishing a second bearer for the application server to transmit downlink communication to the user equipment obtaining V2X services; and
transmitting uplink and downlink communication between the user equipment and the application server.

2. The method according to claim 1, wherein the establishing the first bearer comprises establishing the first bearer by an evolved Node B.

3. The method according to claim 1, wherein the establishing the first bearer comprises establishing the first bearer for the user equipment to transmit uplink communication to a V2X application server.

4. The method according to claim 1, wherein the establishing the first bearer comprises establishing a unicast bearer, the establishing the second bearer comprises establishing a multimedia broadcast multicast service bearer, and the network node comprises an evolved Node B in a specific area.

5. The method according to claim 1, wherein the transmitting of the downlink communication comprises broadcasting a multicast-broadcast single-frequency network broadcast in an area corresponding to a temporary mobile group identity, wherein the temporary mobile group identity is allocated by the application server.

6. The method according to claim 1, wherein the transmitting of the downlink communication comprises broadcasting a single-cell point-to-multipoint broadcast in an area corresponding to a temporary mobile group identity, wherein the temporary mobile group identity is allocated by the application server.

7. The method according to claim 1, further comprising:
establishing an infrastructure-to-vehicle broadcast channel, wherein the infrastructure-to-vehicle broadcast channel is dedicated to the broadcasting of infrastructure-to-vehicle messages; and
broadcasting an indication that the infrastructure-to-vehicle broadcast channel is supported, wherein the indication comprises an indication broadcasted over a system information broadcast.

8. The method according to claim 1, further comprising:
establishing a tunnel between a first local gateway and a second local gateway, when the user equipment has moved beyond a serving area of the first local gateway into a serving area of the second local gateway.

9. The method according to claim 1, wherein the transmitting the uplink communication between the user equipment and the application server comprises:
determining a destination internet protocol address of the uplink communication; and
determining an appropriate tunnel for the uplink communication based on the determined internet protocol address, a tunnel identity, and/or port numbers, wherein a routing table indicates the appropriate tunnel for communication with the determined internet protocol address, and the uplink communication is forwarded towards a local gateway and the application server via the determined tunnel.

10. An apparatus, comprising:
at least one processor; and
at least one memory including computer program code,
the at least one memory and the computer program code configured, with the at least one processor, to cause the apparatus at least to
establish a first bearer for user equipment to transmit uplink communication to an application server, wherein the user equipment is configured for vehicle-to-vehicle or vehicle-to-infrastructure communication;
establish a second bearer for the application server to transmit downlink communication to the user equipment obtaining V2X services; and
transmit uplink and downlink communication between the user equipment and the application server.

11. The apparatus according to claim 10, wherein the apparatus comprises an evolved Node B.

12. The apparatus according to claim 10, wherein the establishing the first bearer comprises establishing the first bearer for the user equipment to transmit uplink communication to a V2X application server.

13. The apparatus according to claim 10, wherein the establishing the first bearer comprises establishing a unicast bearer, the establishing the second bearer comprises establishing a multimedia broadcast multicast service bearer, and the apparatus comprises an evolved Node B in a specific area.

14. The apparatus according to claim 10, wherein the transmitting of the downlink communication comprises broadcasting a multicast-broadcast single-frequency network broadcast in an area corresponding to a temporary mobile group identity, wherein the temporary mobile group identity is allocated by the application server.

15. The apparatus according to claim 10, wherein the transmitting of the downlink communication comprises broadcasting a single-cell point-to-multipoint broadcast in an area corresponding to a temporary mobile group identity, wherein the temporary mobile group identity is allocated by the application server.

16. The apparatus according to claim 10, wherein the apparatus is further caused to:
establish an infrastructure-to-vehicle broadcast channel, wherein the infrastructure-to-vehicle broadcast channel is dedicated to the broadcasting of infrastructure-to-vehicle messages; and
broadcast an indication that the infrastructure-to-vehicle broadcast channel is supported, wherein the indication comprises an indication broadcasted over a system information broadcast.

17. The apparatus according to claim 10, wherein the apparatus is further caused to:
establish a tunnel between a first local gateway and a second local gateway, when the user equipment has moved beyond a serving area of the first local gateway into a serving area of the second local gateway.

18. The apparatus according to claim 10, wherein the transmitting the uplink communication between the user equipment and the application server comprises:
determining a destination internet protocol address of the uplink communication; and
determining an appropriate tunnel for the uplink communication based on the determined internet protocol address, a tunnel identity, and/or port numbers, wherein a routing table indicates the appropriate tunnel for communication with the determined internet protocol address, and the uplink communication is forwarded towards a local gateway and the application server via the determined tunnel.

19. A computer program product, embodied on a non-transitory computer readable medium, the computer program product configured to control a processor to perform a method according to claim 1.
